(19) United States
(12) Patent Application Publication
(10) Pub. No.: US 2016/0014867 A1
(43) Pub. Date: Jan. 14, 2016

(54) Device for providing automatic power to different lamp types

(71) Applicant: John F. Luk, Flushing, NY (US)

(72) Inventor: John F. Luk, Flushing, NY (US)

(73) Assignee: John F. Luk, Flushing, NY (US)

(21) Appl. No.: 14/120,951

(22) Filed: Jul. 14, 2014

(51) Int. Cl. H05B 37/02

(52) U.S. Cl. CPC H05B 37/02

(57) ABSTRACT

A device with an integral microprocessor controlled electronics that automatically detects and outputs the correct power to energize an incandescent, HID or High Intensity Discharge and fluorescent, and LED or Light Emitting Diode lamps attached to the output of the device. The first or a second integral microprocessor controlled electronics can also be used to automatically detect the type of dimming data control signal that is connected to the input of the device. The range of input data dimming control signals include DMX, RDM, MADLI, DALI, 0-10V, Ethernet, leading edge forward phase, and trailing edge reverse phase, etc. An optional user interface port can also be provided on the device for the programming of the device. The end-user will be able to select the output power handling capability of the device either by software using the user interface port, by using input selectable jumpers, or by using hardware switches provided on the device.

### PRIORITY STATEMENT

This patent application claims the benefit of U.S. Provisional Patent Application No. 61/846,042 entitled, “Device for Providing Automatic Power to Different Lamp Types” filed on Jul. 14, 2013.

### FIELD OF THE INVENTION

The present invention relates to a device with an integral microprocessor controlled electronics that will automatically detect and output the correct power to energize incandescent, HID or High Intensity Discharge and fluorescent, and LED or Light Emitting Diode lamps attached to the output of the device.

### BACKGROUND OF THE INVENTION

Incandescent tungsten filament lamps are reliable sources of safe and efficient lighting that were created to overcome dangerous gas lamps. These incandescent lamps were later used with dimmers that controlled the amount of power going into the lamps to provide dimming of the light output for better energy savings. These lamps used lampholders or sockets including E26 and E27 medium screw base, medium bi-pin, and twist-and-lock among the many types of lampholders or sockets available for quartz halogen and incandescent lamps.

HID or metal halide lamps and fluorescent lamps were later discovered that offered increased lamp life and brighter outputs over the incandescent lamps. These HID or fluorescent lamps operated with a ballast that first ignited an arc and then limited the power to the lamp to keep the arc energized. Certain HID or fluorescent lamps could be used with a special ballast that could also dim the lamp down to a certain percentage for additional energy savings. These lamps could also be used with lampholders or sockets like the E26 and E27 medium screw base, etc. similar to the ones used for the quartz halogen and incandescent type of lamps. The sockets used with these HID or fluorescent lamps were capable of use with higher startup voltages and were properly marked as pulse-rated high-voltage ignition lampholders.

Most recently, advances in LED brightness and efficacy have allowed LED lamps to be developed that could offer even brighter outputs and longer lamp life when properly configured to compete with HID or fluorescent lamps. LED retrofit lamps operate on AC power and have built-in internal drivers. Typically, a driver converts the AC power to DC power to energize the LEDs in the lamp either through PWM, constant voltage, or constant current. The LED lamps can also use the same conventional lampholders or sockets used for incandescent and HID or fluorescent lamps. These LED lamps can also be dimmed for additional energy savings.

For the sake of simplicity and uniformity, and particularly to new designs and ease of retrofits, it is desirable and there becomes a need to have one device that can operate with any type of lamp regardless if the lamp is incandescent, HID or fluorescent, and LED. This device will have intelligence built into it that will enable it to act as an incandescent dimmer, an HID or fluorescent ballast, or an LED dimmer that will automatically sense what type of lamp is being connected to the output of the device and will automatically provide the correct power to energize the type of lamp that is connected. This will allow the end-user the ability to use any type of lamp in a particular luminaire that uses this unique and versatile energy saving device.

The present invention is designed to allow luminaire designers to use a single device to power any type of lamp, thereby providing ease of design and quicker release to market products for better energy savings. From a manufacturer's standpoint, a single device will now be stocked that will help reduce inventory and increase their purchasing power. The manufacturer's customers can now have a wider choice of lamp options depending on their preference and illumination needs.

The present invention will also provide convenience and piece of mind for the end user to use any and all types of lamps readily available in the market, without having the concerns of damage to the different types of lamps being used.

### DESCRIPTION OF RELATED ART

Metrolight, Inc. is based out of Israel and is a manufacturer of high-frequency electronic ballasts for use with Metal Halide Lamps with wattages ranging from 70-watts to 400-watts with input voltages from 120-volts up to 277-volts for world-wide usage. In late 2012, they introduced a line of LED drivers with an operating power range of 150-watts to 400-watts with multi-voltage input voltages from 120V to 277V. In essence, they are the same exact ballast hardware that they have been supplying to the industry for operating HID lamps, but now with software programming done either at their factory or by the end-user, the ballast that is used for HID or fluorescent lamps can now be changed to an LED driver when used with their AC to DC LED converter module. Their LED driver can accept 0-10V or a custom MADLI digital signal to allow dimming of the LEDs. At the time of this write-up, they are the only company that have done this, and have filed their own intellectual property applications to secure their inventions.

The device of the present invention eliminates the need for the factory or the end-user to re-program the device to make it act as a ballast or a driver, and vice-versa. The device of the present invention will automatically sense the type of lamp connected to the output of the device and will use its internal micro-processor and electronics to provide the correct power to safely operate any type of lamp being connected whether it is a tungsten filament incandescent lamp, an HID or fluorescent lamp, or an LED lamp. In the case of an LED, the necessary electronics will be on-board to provide the necessary AC power on the output side to operate the LED lamps already provided with internal AC to DC drivers. Since the output of this device will be AC voltage power, it can be used to readily power AC LEDs or AC LED modules including AC LED lamps, but when used with a separate and external AC to DC converting device like a half bridge or full wave diode bridge rectifier, this same device can also be used to power a string of LEDs with DC power.

Light-Based Technologies (LBT) based out of Vancouver, Canada has filed patent applications on their utltra-compatible deep dimming LED drivers. LBT offers a 25-watt LED driver that can detect if an input data dimming control signal is either 0-10V, leading edge forward phase (triac), or trailing edge reverse phase (ELV). They accomplish this by using their LB411 triac deep dimming LED controller base on the LB4 ASIC for solid state lighting applications.

While the LBT driver has automatic sensing of the input data dimming control signal, it does not have the automatic sensing capability of the device of the present invention. The LBT UC1000 series of LED drivers are rated only for a maximum of 25-watts at an input voltage of 90-132V, and provides a DC output that can only be used with a string of LEDs.

The preferred embodiment of the present invention uses an internal micro-processor to automatically sense the type of lamp, i.e. incandescent filament, HID or fluorescent, or LED lamp that is connected to the output of the device. The device will then safely output the proper AC power to energize the different types of lamps that are connected to the output of the device.

An alternate embodiment of the present invention would be to have the device use its internal micro-processor to also include the automatic sensing of the input data dimming control signal for a completely versatile device that can not only automatically sense any type of input data dimming control signal applied to the device, i.e. DMX, RDM, MADLI, DALI, 0-10V, Ethernet, leading edge and trailing edge, etc., but can also safely power any type of lamp, whether it be an incandescent filament lamp, HID or fluorescent lamp, or an LED lamp that is connected to the output of the device using the same microprocessor or a separate internal controller.

### SUMMARY OF THE INVENTION

The device of the present invention is provided with an integral microprocessor controlled electronics that will automatically detect and output the correct power to energize incandescent, HID or High Intensity Discharge and fluorescent, and LED or Light Emitting Diode lamps attached to the output of the device. The total output to the lamp is preset by the user prior to attaching any dimming control signals or power to the device.

The selection of the power rating of the device can be accomplished by way of software by attaching the device to a computer or programming device, by way of jumpers and headers, or with on-board switch settings. When using the software option, an optional interface port will be provided on the device for direct connection and communication with a computer or other equipment for software programming of the device either at the factory or in the field. This interface port can be a simple header, pins, wire leads, USB, serial, or parallel connector.

The power rating can be set in any range typically from 20 W, 35 W, 50 W, 70 W, 75 W, 90 W, 100 W, 120 W, 150 W, etc. or to any setting as determined by the manufacturer. The greater choice of power settings of the device makes the device more versatile for use with a greater number of lamps with a wider range of wattages depending on the need of the user. This predetermined maximum wattage is set by the user prior to using the device and necessary care needs to be taken to make sure that the rating of the lamp is matched to the device setting or overvoltage to the attached lamp could cause premature failure or create an unsafe condition. In other words, the user setting of the device has to be equal to or less than the rating of the lamp that is attached to the device for safe and proper operation.

The device of the present invention includes the automatic detection of any type of lamp connected to the output of the device. The type of lamp can be an incandescent filament lamp, an HID or fluorescent lamp, or an LED lamp. An incandescent filament lamp has a very low resistance when measured across the two pole load of the lamp terminals. The tungsten filament itself will have a very low resistance just above zero resistance or at full load. An HID or fluorescent lamp is an arc gap type of lamp that will have no resistance or will register an open or no load condition. Lastly, for a DC LED lamp, the resistance across the anode and cathode of the LEDs containing one or more LEDs in series will give out the total voltage drops from all the LEDs, or a very high resistance when testing across the conductors of an AC LED lamp due to the internal driver located within the AC LED lamp. Since the resistive loads are unique and different for each type of lamp, it would be logical to use a microprocessor or simple PLC or PIC programmer to identify the three different output load values, and then have the internal microprocessor provide the corresponding type of power to the output of the device required to safely and properly operate the type of lamp that is connected to the device.

If the microprocessor determines the resistive load is low, it knows an incandescent type of lamp is connected. The device therefore outputs an AC voltage in the same range as the input AC voltage connected to the power leads of the device and at the predetermined maximum wattage previously selected by the user. If the microprocessor determines there is no resistive load or an open, then it knows that a type of arc lamp of the HID or fluorescent family is connected. The device therefore sends an initial high voltage to ignite the arc and then lower it to an operating level equal to or below the same range as the input AC connected to the power leads of the device, and at the predetermined maximum wattage previously selected by the user. If the microprocessor now determines the resistive load is high or a capacitive load is present, it will know an LED type of lamp is connected and therefore outputs an AC voltage and current to the output of the device at a predetermined maximum wattage previously selected by the user. For a DC LED lamp, an external AC to DC converter is used when one or more LED strings are connected to a DC voltage, it will continue to draw power from the device until it exceeds the forward voltage of one or the sum of all the forward voltages of all the LEDs in the string. Once this voltage is set, the current is then increased until the total power output to the LEDs reaches the predetermined maximum wattage previously selected by the user.

Once the device determines the type of lamp that is connected to the output of the device, it can store this information in volatile random access memory or VRAM and will know to operate the same type of lamp already used in a particular luminaire. In the case of a short circuit on the output connections of the device, the internal microprocessor will know this and will stop sending power to the output until which time the short circuit condition has been removed. In the event of no connection to the output of the device, the microprocessor will first see it as an HID or fluorescent lamp and will try to ignite the output, if no ignition occurs then the microprocessor will know that no lamps are attached to the output of the device and the internal microprocessor will know this and will stop sending power to the output until which time a lamp is attached to the output of the device. Lastly, an optional NTC thermistor connection may be provided on the device as a feedback from an on-board resistor mounted on the LED printed circuit board, or in close proximity to the LEDs to let the device know if the LEDs are being over driven and may lead to excessive thermal stress to the LEDs. The NTC works only when the load on the device output is an LED lamp.

The preferred embodiment is therefore a non-dimmable device that has a power input side that accepts 90V to 277V AC voltage, and an output side that connects to any type of a two pole lamp including an incandescent filament lamp, an HID or fluorescent lamp, or an LED lamp. The device has an internal microprocessor that tests the output lines and automatically determines the type of lamp that is connected to the device, and will output the maximum power to the lamp based on the user selected power rating of the device. The device will also know if the output is a short circuit or if there is no lamp connected to the output of the device. In both cases, the device will not provide power to the output until the short circuit is removed or a lamp is connected to the output.

The device of the present invention may also include an automatic detection of the dimming control signal connected to the input of the device, thereby making the device now a dimmable device. The input dimming control signals can include DMX, RDM, MADLI, DALI, 0-10V, Ethernet, leading edge, and trailing edge phase control.

The alternate embodiment is therefore a dimmable device that has a power input side that accepts 90V to 277V AC voltage, a data input side that accepts a dimming data control signal, and an output side that connects to any type of two pole lamp that can be an incandescent filament lamp, an HID or fluorescent lamp, or an LED lamp. The device has an internal microprocessor that will first monitor and test the low voltage input dimming data control signal lines to determine if the input signal is DMX, RDM, MADLI, DALI, 0-10V, or Ethernet is present. If no low voltage dimming signal is present, then the microprocessor will next test the high voltage power input lines to see if there is a mains dimmable forward phase leading edge dimmer or a mains dimmable reverse phase trailing edge dimmer is attached. If not then the dimming data control lines are ignored. Likewise, the device has an internal microprocessor that will test the output lines and automatically determine the type of lamp that is connected to the device. The device will then output the maximum power to the lamp based on the user selected power rating of the device. The device will also know if the output is a short or if there is no lamp connected at all, and in both cases the device will not provide power to the output until the short or a lamp is connected.

### OBJECT OF THE INVENTION

It is an object of the present invention to provide one device that will work with any type of lamp.

It is another object of the present invention to provide one device that will automatically sense the type of lamp connected to the output.

It is yet another object of the present invention to provide one device that will work with any type of lamp connected to the output of the device, and that will work with any type of data dimming control signal connected to the input of the device.

It is also another object of the present invention to provide one device that will automatically sense the type of lamp connected to the output, and will automatically sense the type of data dimming control signal connected to the input.

It is also yet another object of the present invention to provide one device where the end-user can easily select one of a multiple number of power settings for the device.

Lastly, it is a final object of the present invention to provide a user interface port for the programming of the one device of the present invention including the maximum power output of the device of the present invention to any type of lamp that is connected to the output of the device.

While the novel features of the invention are set forth particularly in the appended claims, the invention, both as to organization and content, will be better understood and appreciated along with other objects and features thereof, from the following detailed description taken in conjunction with the drawings.

### BRIEF DESCRIPTION OF THE DRAWINGS

FIG. 1 shows the preferred embodiment of the present invention in a basic diagram for a device with an automatic output detection system for different types of lamps.

FIG. 2 shows an alternate embodiment of the present invention in a basic diagram for a device with an automatic input dimming data control signal detection system including DMX, RDM, MADLI, DALI, 0-10V, and Ethernet on the low voltage data input signal lines or leading edge forward phase, and trailing edge reverse phase control signals present on the AC high voltage input power lines along with an automatic output detection system for different lamp types.

FIG. 3 shows a typical flowchart for the logic contained in the internal microprocessor and electronics for the determination of the lamp type connected to the output of the device of the present invention according to FIG. 1.

FIG. 4 shows a typical flowchart for the logic contained in the internal microprocessor and electronics for the determination of the type of input dimming control signal connected to the input of the device of the present invention according to

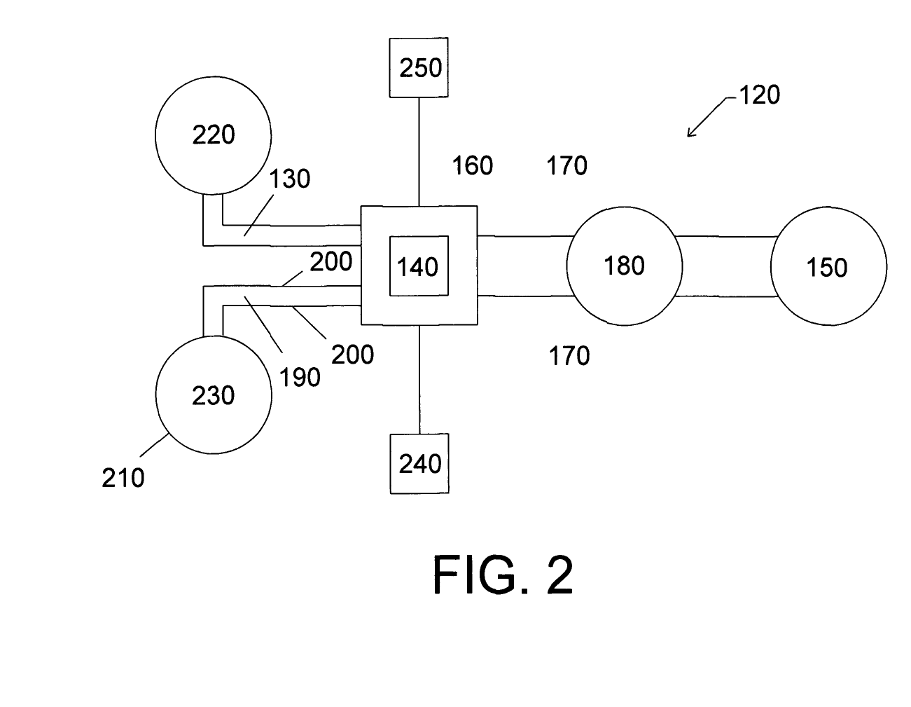

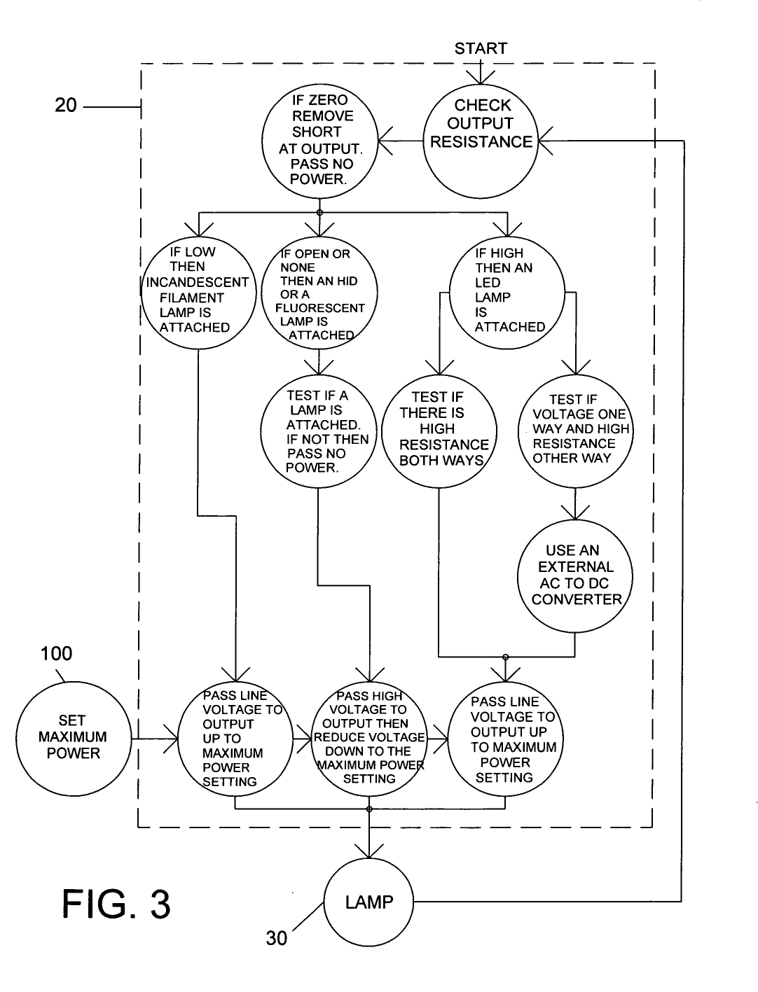

FIG. 2 to operate in conjunction with the automatic output detection system for different lamp types according to FIG. 3.

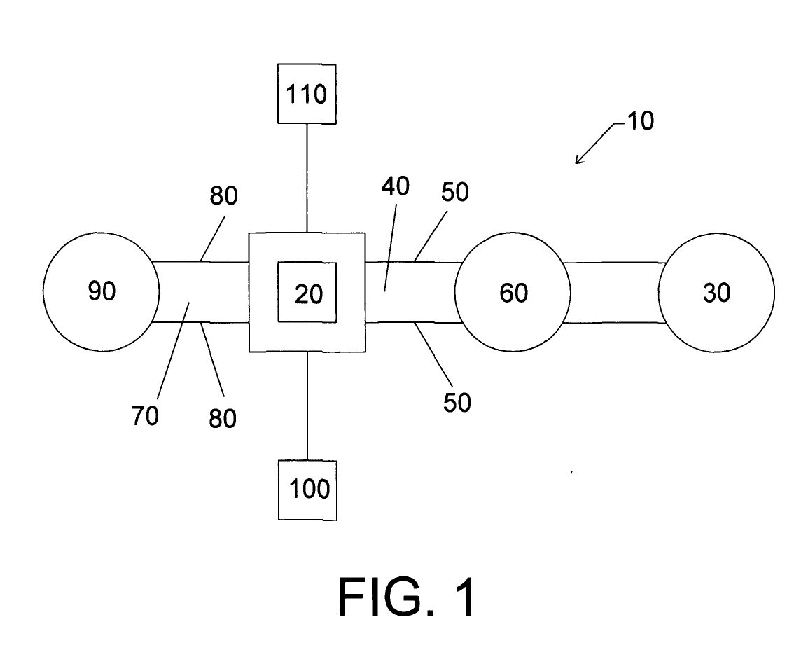

FIG. 5 shows the user selectable power settings for the present invention as shown in FIG. 1 and FIG. 2 to select the power handling capability of the device either by software, by using input selectable jumpers, or switches for the proper power output to the lamp connected to the device.

FIG. 6 shows an optional user interface port for communications with the microprocessor contained in the device of the present invention as shown in FIG. 1 and FIG. 2 for programming the device including programming the maximum power output to the lamp connected to the device.

The foregoing has outlined rather broadly, the features and technical advantages of the present invention, so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

### DETAILED DESCRIPTION

FIG. 1 shows a device 10 with an internal microprocessor 20 and electronics to monitor the type of lamp 30 connected to the output 40 of the device 10. The output 40 of the device 10 consists of at least two conductors 50. The at least two output conductors 50 can be connected to a two conductor lampholder or socket 60, or it can be connected directly to a two conductor lamp 30. Power is applied to the input 70 of the device 10 with at least two input conductors 80. In this example, the power is line voltage AC 90. Internally, the AC voltage 90 is converted to DC voltage (not shown) to provide power to the internal microprocessor 20 and electronics. Depending on the type of lamp 30 connected to the at least two conductors 50 at the output 40 of the device 10, the device 10 will provide the proper power to safely operate the lamp 30. A set of jumpers or switches 100 are in communications with the internal microprocessor 20 and electronics to set the maximum output power of the device 10 to the at least two output conductors 50 for connection to an at least two conductor lampholder or socket 60, or for direct connection to an at least two conductor lamp 30. If a manual setting of the jumpers or switches 100 is not accessible during normal operation of the device 10, a bypass setting (not shown) can be made such that the configuration of the maximum output power of the device 10 is instead set by software programming by way of an easily accessible and optional interface port 110 provided to the user for this purpose. The optional interface port 110 is also in direct communication with the internal microprocessor 20 and electronics.

FIG. 2 shows an alternate device 120 similar to the device 10 shown in FIG. 1 with the addition of at least two input conductors 130. This device 120 contains an internal microprocessor 140 and electronics to monitor the type of lamp 150 connected to the output 160 of the device 120. The same internal microprocessor 140 and electronics or a secondary internal microprocessor (not shown) and electronics also monitors the input 130 of the device 120 for the type of dimming control signal 220 being applied to the device 120 for dimming of the lamp 150 connected to the output 160 of the device 120. The output 160 of the device 120 consists of at least two output conductors 170. The at least two output conductors 170 can be connected to a two conductor lampholder or socket 180, or it can be connected directly to a two conductor lamp 150. Power is applied to the input 190 of the device 120 with at least two input conductors 200. In this example, the power is line voltage AC 210. Internally, the AC voltage 210 is converted to DC voltage (not shown) to provide power to the internal microprocessor 140 and electronics. Depending on the type of lamp 150 connected to the at least two conductors 170 at the output 160 of the device 120, the device 120 will provide the proper power to safely operate the lamp 150.

There is provided at least two conductors 130 for connecting a low voltage input dimming control signal 220 to the device 120. The low voltage input dimming control signal 220 can be DMX, RDM, MADLI, DALI, 0-10V, or Ethernet. The at least two low voltage input dimming control conductors 130 are in direct communication with the first internal microprocessor 140 and electronics or with a second internal microprocessor (not shown) and electronics. If there is no low voltage dimming control signal 220 applied to the at least two input low voltage input dimming control conductors 130, then the first internal microprocessor 140 and electronics or second internal microprocessor (not shown) and electronics will then monitor the at least two high voltage input conductors 200 to determine if there is a high voltage input dimming control signal 230 present there. The high voltage input dimming control signal 230 can be a leading edge forward phase or a trailing edge reverse phase signal. If no input dimming control signal 220, 230 is present either in the at least two low voltage input dimming control conductors 130 or in the at least two high voltage input power conductors 200, then the device 120 will simply operate as an on and off device 120 with no dimming of the lamp 150 that is connected to the output 160 of the device 120 to the at least two output conductors 170. A set of jumpers or switches 240 are in communications with the internal microprocessor 140 and electronics to set the maximum output power of the device 120 to the at least two output conductors 170 for connection to an at least two conductor lampholder or socket 180, or for direct connection to an at least two conductor lamp 150. If a manual setting of the jumpers or switches 240 is not accessible during normal operation of the device 120, a bypass setting (not shown) can be made such that the configuration of the maximum output power of the device 120 is instead set by software programming (not shown) by way of an easily accessible and optional interface port 250 provided to the user for this purpose. The optional interface port 250 is also in direct communication with the internal microprocessor 140 and electronics.

FIG. 3 shows a typical flowchart for the logic contained in the microprocessor 20 and electronics for the determination of the lamp 30 type connected to the output 40 of the device 10 as show in FIG. 1. The maximum power rating of the device 10 has to be set first on the device 10 either by software programming (not shown) using the optional interface port 110 provided to the user, or by manually setting the on-board jumpers or switches 100 to the desired lamp wattage rating. Once this is done, power is applied to the device 10 at which time the internal microprocessor 20 and electronics will check the output resistance of the lamp 30 that is connected to the at least two output conductors 50 of the device 10.

If the condition shows zero resistance, then the microprocessor 20 knows that there is a short circuit between the at least two output conductors 50 of the device 10 and no power is sent to the output 40 of the device 10. The device 10 will not send power to the output 40 until the short circuit or zero resistance condition is removed. Once the zero resistance is not present, the microprocessor 20 will check for a low, a null, or a high resistance condition. In the case of a low resistance, the microprocessor 20 will know that an incandescent tungsten type lamp 30 is attached to the at least two output conductors 50 of the device 10. The microprocessor 20 will then pass the line voltage AC 90 to the output 40 of the device 10 up to the maximum power setting of the device 10. In the case of a null or no resistance, the microprocessor 20 will know that an HID or fluorescent type lamp 30 may be attached to the at least two output conductors 50 of the device 10, or there is an open condition indicating that no lamp 30 is connected to the at least two output conductors 50 of the device 10. In both cases, the microprocessor 20 will send a test ignition voltage (not shown) to the at least two output conductors 50 of the device 10 to determine if there is indeed a lamp 30 attached to the at least two output conductors 50 of the device 10. Once a lamp 30 is verified to be connected to the at least two output conductors 50 of the device 10, the microprocessor 20 will then pass the high voltage (not shown) to the output 40 to strike the HID or fluorescent lamp 30, and then lower the voltage (not shown) down to the maximum power setting of the device 10 and maintain the arc (not shown) for normal lamp 30 operation. In the case of a high resistance, the microprocessor 20 will know that an AC LED type lamp 30 is attached to the at least two output conductors 50 of the device 10. The microprocessor 20 will then pass the line voltage AC 90 to the output 40 of the device 10 up to the maximum power setting of the device 10.

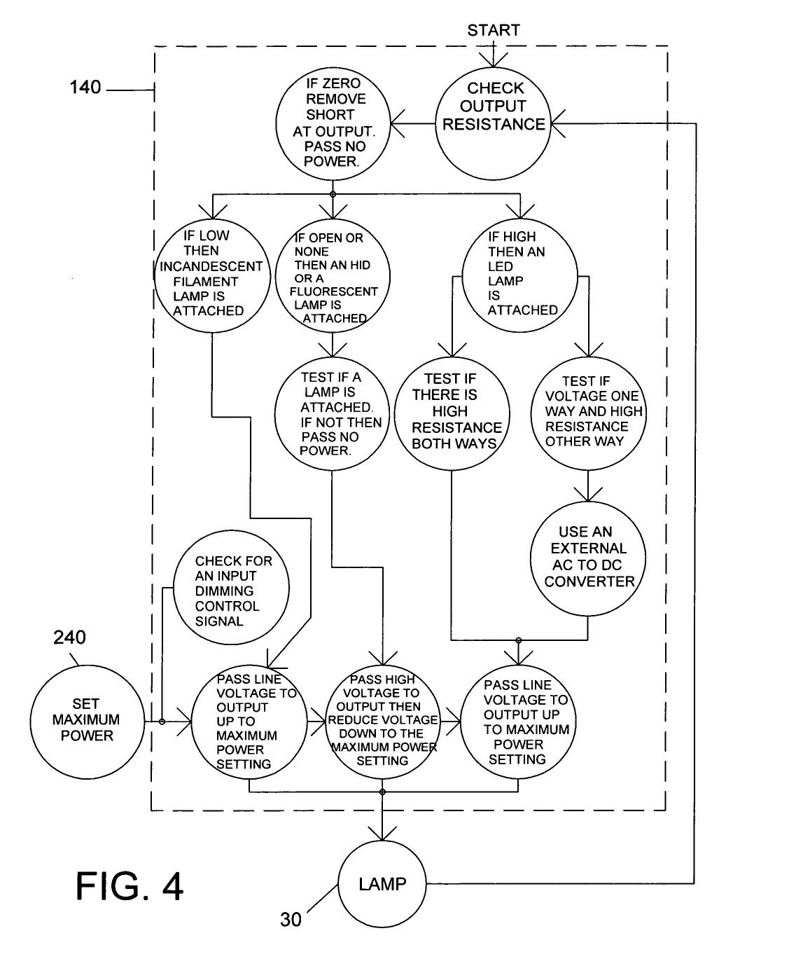

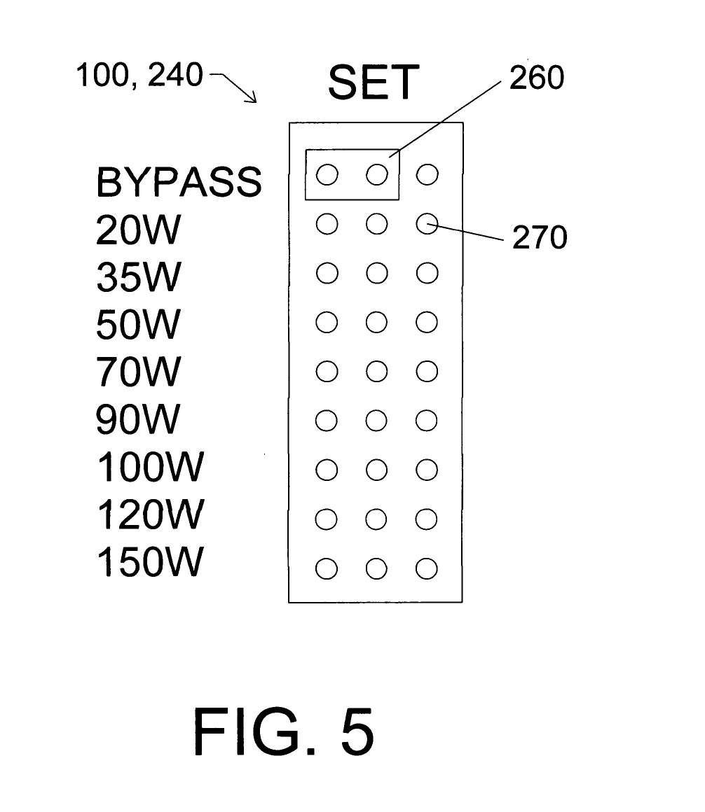

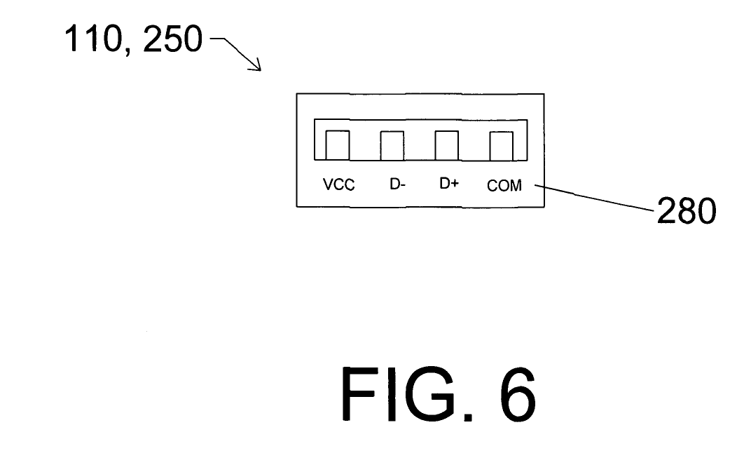

FIG. 4 shows a typical flowchart for the logic contained in the microprocessor 140 and electronics for the determination of the type of dimming control signal 220, 230 connected to the input 130, 190 of the device 120 as shown in FIG. 2. The input dimming data control signals 220, 230 may include DMX, RDM, MADLI, DALI, 0-10V, and Ethernet on the low voltage data input signal lines 130, or leading edge forward phase and trailing edge reverse phase control signals on the AC high voltage input power lines 190. The maximum power rating of the device 120 has to be set first on the device 120 either by software programming (not shown) using the optional interface port 250 provided to the user, or by manually setting the on-board jumpers or switches 240 to the desired lamp wattage rating. Once this is done, power is applied to the device 120 at which time the internal microprocessor 140 and electronics will next check the at least two low voltage input dimming control signal data conductors 130 to determine if there is any low voltage input dimming control signal 220 present. If not present, the microprocessor 140 then checks the at least two high voltage input power conductors 200 to see if there is a leading edge dimming signal 230 or a trailing edge dimming signal 230 present on the at least two output conductors 200 of the device 140.

While this is occurring, the same microprocessor 140 and electronics or a secondary microprocessor (not shown) and electronics will be in constant communications together and will simultaneously check for the type of lamp 150 connected at the output 160 of the device 120.

If the condition shows zero resistance, then the microprocessor 140 knows that there is a short circuit between the at least two output conductors 170 of the device 120 and no power is sent to the output 160 of the device 120. The device 120 will not send power to the output 160 until the short circuit or zero resistance condition is removed. Once the zero resistance is not present, the microprocessor 140 will check for a low, a null, or a high resistance condition. In the case of a low resistance, the microprocessor 140 will know that an incandescent tungsten type lamp 150 is attached to the at least two output conductors 170 of the device 140. The microprocessor 140 will then pass the line voltage AC 210 at a dimmed level to the output 160 of the device 120 up to the maximum power setting of the device 120. In the case of a null or no resistance, the microprocessor 140 will know that an HID or fluorescent type lamp 150 may be attached to the at least two output conductors 170 of the device 120, or there is an open condition indicating that no lamp 150 is connected to the at least two output conductors 170 of the device 120. In both cases, the microprocessor 140 will send a test ignition voltage (not shown) to the at least two output conductors 170 of the device 120 to determine if there is indeed a lamp 150 attached to the at least two output conductors 170 of the device 120. Once a lamp 150 is verified to be connected to the at least two output conductors 170 of the device 120, the microprocessor 140 will then pass the high voltage (not shown) to the output 160 to strike the HID or fluorescent lamp 150, and then lower the voltage (not shown) to a dimmed level down to the maximum power setting of the device 120, and maintain the arc for normal lamp operation. In the case of a high resistance, the microprocessor 140 will know that an AC LED type lamp 150 is attached to the at least two output conductors 170 of the device 120. The microprocessor 140 will then pass the line voltage AC 210 at a dimmed level to the output 160 of the device 120 up to the maximum power setting of the device 120.

FIG. 5 shows a typical hardware manual jumper setting 100, 240 as shown in FIG. 1 and FIG. 2 for the maximum power setting of the device 10, 120. The user can place a jumper 260 in the respective header 270 position to set the maximum power output 40, 160 of the device 10, 120 to operate with a particular type of lamp 30, 150 the user intends to use with the device 10, 120. If the user prefers to set the power output 40, 160 in software, the jumper 260 will be placed in the bypass position. Note that FIG. 5 shows a jumper 260 and header 270 setup, but other manual selections can be done with switches 100, 240 and other hardware selecting components.

FIG. 6 shows an optional user interface port 110, 250 as shown in FIG. 1 and FIG. 2 that can be provided on the device 10, 120 of the present invention for direct communications with the microprocessor 20, 140 and electronics contained in the device 10, 120. This optional user interface port 110, 250 can be used for programming the device 10, 120 including the maximum power output 40, 160 to a lamp 30, 150 connected to the device 10, 120. What is shown in FIG. 6 is a USB port 280 with four pins designated as VCC, Data−, Data+, and COM corresponding to Pins 1, 2, 3, and 4 respectively. USB port 280 is just one example of an optional user interface port 110, 250 as shown in FIG. 1 and FIG. 2. The use of USB ports 280 for communications between devices 10, 120 and computers (not shown) have become a widely accepted practice, however someone skilled in the arts will note that many other types of headers and connectors (not shown) can be utilized as the main optional user interface port 110, 250 in the device 10, 120 of the present invention.

Although the present invention has been described in terms of the presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention. It will be understood that the various changes in the details, materials, types, values, and arrangements of the components that have been described and illustrated here in order to explain the nature of this invention may be made by those skilled in the art without departing from the principle and scope of the invention as expressed in the following claims.

What is claimed is:

1. A device for automatically detecting and powering different lamp loads including:
a first input section in said device for accepting input power,
a microprocessor with software to determine the type of lamp attached to an output section of said device,
means to set the maximum output power rating of said device, and
electronics to convert said input power to match the set maximum output power to said different lamp loads attached to said output section of said device.

2. A device for automatically detecting and powering different lamp loads according to claim 1 further including:
a second input section in said device for accepting dimming data control signals,
a microprocessor and software to automatically detect the type of said dimming data control signal connected to said second input section of said device, and controlling said electronics to convert said input power to match the set maximum output power to said different lamp loads attached to said output section of said device.

3. A device for automatically detecting and powering different lamp loads according to claim 2 wherein:
said dimming data control signals include DMX, RDM, MADLI, DALI, 0-10V and Ethernet.

4. A device for automatically detecting and powering different lamp loads according to claim 2 wherein:
said second input section is said first input section.

5. A device for automatically detecting and powering different lamp loads according to claim 4 wherein:
said dimming data control signals include leading edge forward phase and trailing edge reverse phase.

6. A device for automatically detecting and powering different lamp loads according to claim 1 wherein:
said means to set the maximum output power rating of said device include manual hardware jumper switch settings provided on said device.

7. A device for automatically detecting and powering different lamp loads according to claim 1 wherein:
said means to set the maximum output power rating of said device include hardware switch settings provided on said device.

8. A device for automatically detecting and powering different lamp loads according to claim 1 wherein:
said means to set the maximum output power rating of said device include programming the maximum output power rating of said device via a software programming port provided on said device.
